(19) United States
(12) Patent Application Publication
(10) Pub. No.: US 2026/0204048 A1
(43) Pub. Date: Jul. 16, 2026

(54) REPRESENTATION METHOD, SEARCH METHOD, MODEL TRAINING METHOD, DEVICE, AND STORAGE MEDIUM

(71) Applicant: Hangzhou Alibaba International Internet Industry Co., Ltd., Hangzhou City (CN)

(72) Inventors: Boxuan ZHANG, Hangzhou (CN); Chao WEI, Hangzhou (CN); Yan JIN, Hangzhou (CN); Weiru ZHANG, Hangzhou (CN); Haihong TANG, Hangzhou (CN)

(21) Appl. No.: 19/564,859

(22) Filed: Mar. 12, 2026

Related U.S. Application Data
(63) Continuation of application No. PCT/CN2024/106301, filed on Jul. 19, 2024.

(30) Foreign Application Priority Data
Sep. 27, 2023 (CN) 202311268796.4

(51) Int. Cl. G06V 10/77; G06N 3/088; G06T 7/11; G06T 7/194; G06V 30/148

(52) U.S. Cl. CPC G06V 10/7715; G06N 3/088; G06T 7/11; G06T 7/194; G06V 30/153

(57) ABSTRACT

A method for generating a representation of a search object comprises: obtaining a textual description of a search object and an image of the search object; dividing the image of the search object into a plurality of image patches, performing feature extraction on the plurality of image patches respectively through an image feature extraction model, and obtaining a feature sequence of the plurality of image patches; extracting a pixel-level feature from the image of the search object through a text feature extraction model, and determining a representation vector of the search object based on the feature sequence, the pixel-level feature, and the image of the search object. Since the extracted feature sequence and pixel-level feature represent high-level and low-level features of the image, the determined features of the image of the search object are comprehensive and accurate, and the constructed representation vector of the search object is accurate.

### CROSS-REFERENCE TO RELATED APPLICATIONS

This application is a Continuation Application of International Patent Application No. PCT/CN2024/106301, filed on July 19, 2024, which is based on and claims priority to and benefits of the Chinese patent application filed with the China National Intellectual Property Administration on September 27, 2023, with application number 202311268796.4, and entitled "Representation Method, Search Method, Model Training Method, Device, and Storage Medium." The above-referenced applications are incorporated herein by reference in their entirety.

### TECHNICAL FIELD

Embodiments of the present specification relate to the artificial intelligence technical field, and in particular, to a representation method, a search method, a model training method, a device, and a storage medium.

### BACKGROUND

In various search scenarios, after a search system obtains a search term input by a user, the search system can obtain candidate objects with high relevance to the search term from a large number of search objects stored in a database, and then display relevant information of these candidate objects to the user. Currently, in the recall stage of a search scenario, search objects highly associated with a search term are mostly determined by determining the similarity between the search term and the textual description of the search object (i.e., through matching between texts). Since the textual description of the search object and the search term are respectively constructed by different users, there are large differences in structure, sentence length, description habits, and the like. Merely emphasizing the matching between the search term and the textual description may lead to scenarios where the image of the finally recalled search object does not match the search term, which seriously affects the user experience.

### SUMMARY

To overcome the problems existing in the related art, embodiments of the present specification provide a representation method, a search method, a model training method, a device, and a storage medium.

According to a first aspect of the embodiments of the present specification, a method for generating a representation of a search object is provided, the method comprising:

obtaining a textual description of a search object and an image of the search object;

dividing the image of the search object into a plurality of image patches, performing feature extraction on the plurality of image patches respectively through an image feature extraction model, and obtaining a feature sequence of the plurality of image patches; where the image feature extraction model is obtained by pre-training using a general image dataset;

extracting a pixel-level feature from the image of the search object through a text feature extraction model, and determining a representation vector of the search object through the text feature extraction model based on the feature sequence, the pixel-level feature, and the image of the search object; where the text feature extraction model is obtained by training based on historical search data.

According to a second aspect of the embodiments of the present specification, a search method is provided, the method comprising:

obtaining a search term input by a user and representation vectors of a plurality of search objects, where the representation vector of the search object is obtained through the representation method mentioned in the first aspect;

determining a representation vector of the search term using a text feature extraction model;

determining a candidate object from the plurality of search objects based on the similarity between the representation vector of the search term and the respective representation vectors of the plurality of search objects, so as to display attribute data of the candidate object to the user.

According to a third aspect of the embodiments of the present specification, a model training method is provided, the method comprising:

obtaining an image of a sample search object;

dividing the image of the sample search object into a plurality of image patches, performing feature extraction on the plurality of image patches respectively through an image feature extraction model, to obtain a sample feature sequence of the plurality of image patches, where the image feature extraction model is obtained by pre-training using a general image dataset;

extracting pixel-level features from the image of the sample search object through an encoder of a preset initial model;

reconstructing the image of the sample search object through a decoder of the initial model based on the sample feature sequence and the pixel-level features to obtain a reconstructed image;

adjusting model parameters of the initial model based on a difference between the reconstructed image and the image of the sample search object to pre-train the initial model;

fine-tuning the pre-trained initial model based on historical search data to obtain a text feature extraction model.

According to a fourth aspect of the embodiments of the present specification, a model training method is provided, the method comprising:

obtaining a hot search term corresponding to a sample search object, a textual description of the sample search object, and an image of the sample search object;

concatenating the hot search term of the sample search object and the textual description of the sample search object to obtain concatenated text;

dividing the image of the sample search object into a plurality of image patches, performing feature extraction on the plurality of image patches respectively through an image feature extraction model, to obtain a sample feature sequence of the plurality of image patches, where the image feature extraction model is obtained by pre-training using a general image dataset;

inputting the sample feature sequence, the image of the sample search object, and the concatenated text into a preset initial model, and outputting a predicted result through the initial model, the predicted result being used to indicate whether the concatenated text and the image of the sample search object match;

adjusting model parameters of the initial model based on a deviation between the outputted predicted result and a ground truth to pre-train the initial model;

fine-tuning the pre-trained initial model based on historical search data to obtain a text feature extraction model.

According to a fifth aspect of the embodiments of the present specification, a model training method is provided, the method comprising:

pre-training a preset initial model based on historical search data;

obtaining sample data, the sample data including a sample search term, an image of a sample search object, and a textual description of the sample search object;

dividing the image of the sample search object into a plurality of image patches, performing feature extraction on the plurality of image patches respectively through the image feature extraction model, to obtain a sample feature sequence of the plurality of image patches, where the image feature extraction model is obtained by pre-training using a general image dataset;

inputting the sample search term, the image of the sample search object, the textual description of the sample search object, and the sample feature sequence into the pre-trained initial model, and outputting a representation vector of the sample search term and a representation vector of the sample search object through the pre-trained initial model;

inputting the representation vector of the sample search term and the representation vector of the sample search object respectively into a preset discriminator, and using the discriminator to determine a type to which the inputted representation vector belongs, the type including a search term or a search object;

determining a target loss based on a difference between a determination result of the discriminator and a ground truth;

adjusting model parameters of the pre-trained initial model according to the target loss to train and obtain the text feature extraction model.

According to a sixth aspect of the embodiments of the present specification, an electronic device is provided, the electronic device comprising a processor, a memory, and a computer program stored in the memory and executable by the processor, where the computer program, when executed, implements the method mentioned in the first aspect.

According to the seventh aspect of the embodiments of the present specification, a computer storage medium is provided, the computer storage medium having a computer program stored thereon, where the computer program, when executed by a processor, implements the method mentioned in the first aspect, the second aspect, the third aspect, the fourth aspect, and/or the fifth aspect.

Beneficial effects of the embodiments of the present specification: in the solution of the embodiments of the present disclosure, when determining the representation vector of the search object, the image of the search object can be first subjected to patch processing to obtain a plurality of image patches of the search object, and then the pre-trained image feature extraction model is used to perform feature extraction on the plurality of image patches respectively to obtain a feature sequence of the image patches. By cutting an entire image into a plurality of image patches, it is convenient for the image feature extraction model to understand the image and extract finer-grained features, and since the image feature extraction model is a model specifically used for image feature extraction, it can extract some implicit, high-order image patch features from the image patches. Meanwhile, considering that the image feature extraction model is obtained by pre-training using a general image dataset, these image datasets have a certain deviation from the image of the search object, resulting in that the extracted feature sequence of the image patches may not be comprehensive and accurate. Therefore, the text feature extraction model can be further used to perform feature extraction on the original image of the search object to extract some low-order pixel-level features therefrom, and then the text feature extraction model can combine the pixel-level features, the feature sequence of the image patches, and the text features extracted from the textual description of the search object to obtain the representation vector of the search object. Since the feature sequence extracted by the image feature extraction model and the pixel-level features extracted by the text feature extraction model respectively represent high-level and low-level features of the image, the finally determined features of the image of the search object are more comprehensive and accurate, and thus the representation vector of the search object constructed based on the features of the image and the text features of the textual description is also more accurate.

It should be understood that the above general description and the following detailed description are only exemplary and explanatory, and do not limit the embodiments of the present specification.

### BRIEF DESCRIPTION OF THE DRAWINGS

The drawings herein are incorporated into the specification and constitute a part of the embodiments of the present specification, showing embodiments consistent with the embodiments of the present specification, and are used together with the specification to explain the principles of the embodiments of the present specification.

FIG. 1 is a schematic diagram of recalling candidate objects based only on text matching in the related art;

FIG. 2 is a schematic diagram illustrating a mismatch between an image of a candidate object recalled based on text matching and a search term according to an exemplary embodiment of the present specification;

FIG. 3 is a schematic diagram illustrating determination of a representation vector of a search object according to an exemplary embodiment of the present specification;

FIG. 4 is a schematic diagram of determining a representation vector of a search object illustrated in an exemplary embodiment of the present specification;

FIG. 5 is a schematic diagram of determining a representation vector of a search object illustrated in an exemplary embodiment of the present specification;

FIG. 6 is a schematic diagram of a search scenario illustrated in an exemplary embodiment of the present specification;

FIG. 7 is a flowchart of a representation method for a search object illustrated in an exemplary embodiment of the present specification;

FIG. 8 is a schematic diagram of extracting a foreground object from an image of a search object and performing partitioning illustrated in an exemplary embodiment of the present specification;

FIG. 9 is a schematic diagram of performing pre-training on an initial model illustrated in an exemplary embodiment of the present specification;

FIG. 10 is a schematic diagram of performing pre-training on an initial model illustrated in an exemplary embodiment of the present specification;

FIG. 11 is a schematic diagram of performing pre-training on an initial model illustrated in an exemplary embodiment of the present specification;

FIG. 12 is a schematic diagram of a training process of a generative adversarial model illustrated in an exemplary embodiment of the present specification;

FIG. 13 is a schematic diagram of performing fine-tuning on a pre-trained initial model illustrated in an exemplary embodiment of the present specification;

FIG. 14 is a schematic diagram of performing fine-tuning on a pre-trained initial model illustrated in an exemplary embodiment of the present specification;

FIG. 15 is a logic block diagram of an electronic device according to an exemplary embodiment of the present specification.

### DETAILED DESCRIPTION OF EMBODIMENT

Exemplary embodiments will be described in detail here, examples of which are shown in the drawings. When the following description refers to the drawings, unless otherwise indicated, the same numbers in different drawings represent the same or similar elements. The implementations described in the following exemplary embodiments do not represent all implementations consistent with the embodiments of the present specification. Instead, they are merely examples of devices and methods consistent with some aspects of the embodiments of the present specification as detailed in the appended claims.

The terminology used in the embodiments of the present specification is for the purpose of describing specific embodiments only and is not intended to limit the embodiments of the present specification. The singular forms "a", "an", and "the" used in the embodiments of the present specification and the appended claims are also intended to include plural forms, unless the context clearly indicates other meanings. It should also be understood that the term "and/or" used herein refers to and includes any or all possible combinations of one or more associated listed items.

It should be understood that although the terms first, second, third, etc. may be used in the embodiments of the present specification to describe various information, the information should not be limited to these terms. These terms are only used to distinguish information of the same type from each other. For example, without departing from the scope of the embodiments of the present specification, first information may also be referred to as second information, and similarly, second information may also be referred to as first information. Depending on the context, the word "if" as used herein may be interpreted as "at the time of..." or "when..." or "in response to determining".

In various search scenarios, after a search system obtains a search term input by a user, the search system can obtain candidate objects with high relevance to the search term from a large number of search objects stored in a database, and then display relevant information of these candidate objects to the user. Usually, each search object includes attribute data, and the attribute data can be used to describe characteristics of the search object. When the search system recalls candidate objects with high association with the search term, the search system can determine the degree of association between the search object and the search term based on the attribute data of the search object. Usually, the attribute data used to describe the characteristics of the search object includes data of a plurality of modalities. For example, the attribute data may be a textual description of the search object, or may be an image of the search object, or may be other types of data.

Currently, in the recall stage of a search scenario, a search object having a high correlation with a search term is mostly determined by determining the similarity between the search term and a textual description of the search object (i.e., through matching between texts). For example, as shown in FIG. 1, a search system usually includes a text feature extraction model 11, and the text extraction model may be various models suitable for processing natural language, such as a BERT model. The text feature extraction model may determine a representation vector of each search object based on the textual description of each search object, and determine a representation vector of a search term input by a user, that is, map both to the same vector space, and then determine a search object having a high correlation with the search term based on the similarity between the two and display the search object to the user. Since the textual description of the search object and the search term are respectively constructed by different users, there are large differences in structure, sentence length, description habits, and the like. Merely emphasizing the matching between the search term and the textual description may lead to a scenario where an image of the finally recalled search object does not match the search term, which seriously affects user experience.

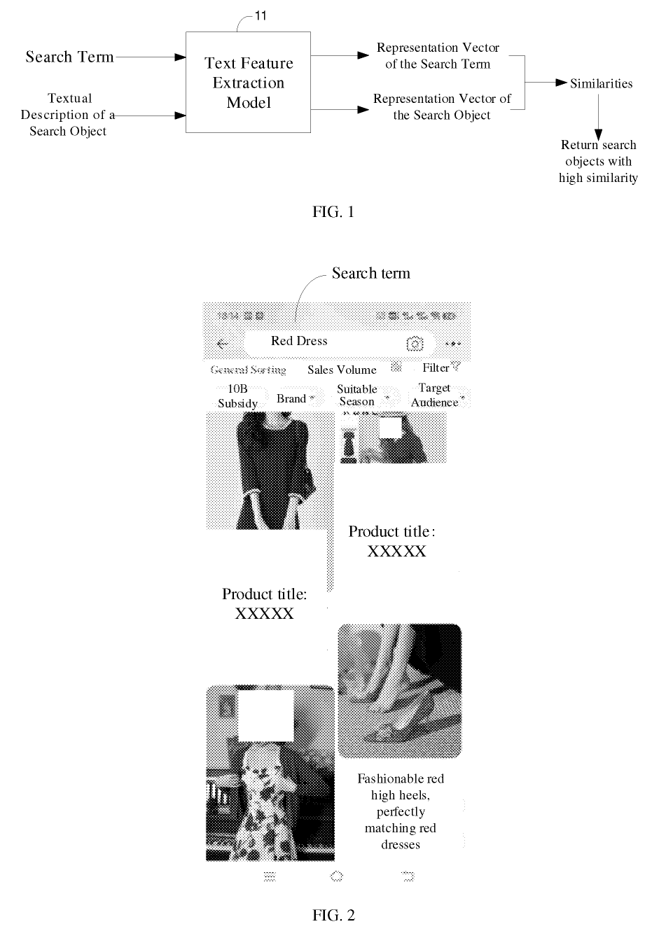

For example, as shown in FIG. 2, taking product recall in an e-commerce scenario as an example, if the search term input by the user is "red dress", and if the recall of related products relies only on whether the search term matches the title (i.e., matching between texts), a product whose title contains the words "red dress" but whose actual main product image is red high-heeled shoes may be presented to the user. For example, the title of certain red high-heeled shoes is "Fashionable red high-heeled shoes, a perfect match with red dresses!". In this case, if based only on text matching, this product will also be recalled and displayed to the user. Obviously, the recalled product clearly does not match the search term input by the user, which will seriously affect user experience.

In order to avoid the above problems, one way that easily comes to mind is to match the textual description of the search object and the image of the search object as a whole with the search term. For example, a representation vector corresponding to the search object may be determined by comprehensively considering the textual description of the search object and the image of the search object, and then matched with the representation vector of the search term to determine a search object with high similarity. However, since most representation models used in current search scenarios are text feature extraction models 11, such models are good at performing feature extraction on text and can accurately obtain representation vectors corresponding to text, but are not good at performing feature extraction on images. As shown in FIG. 3, if the textual description of the search object and the image of the search object are input into the text feature extraction model 11 to determine the representation vector of the search object, the finally determined representation vector of the search object is also inaccurate because the extracted image features are inaccurate.

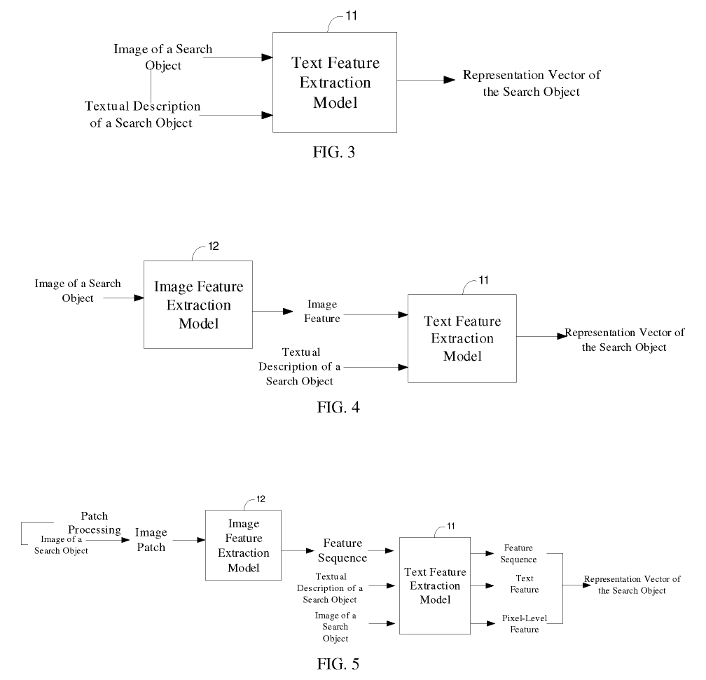

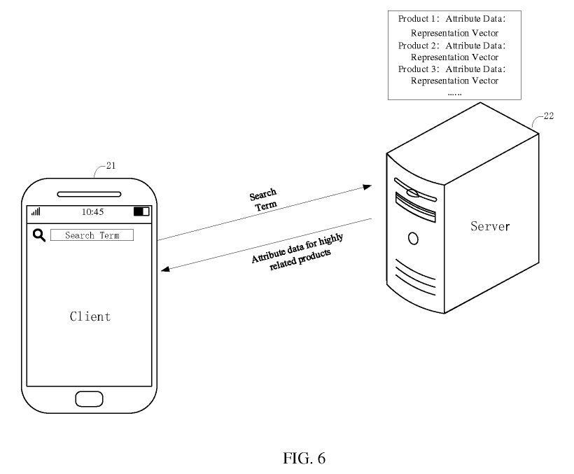

In order to accurately perform feature extraction on images without additional training of a model specifically used for performing feature extraction on images of search objects, as shown in FIG. 4, another way that easily comes to mind is that feature extraction can be performed on an image by means of some open-source pre-trained image feature extraction models 12 (for example, a ResNet model). The text feature extraction model 11 can determine the representation vector of the search object by means of image features extracted from the image of the search object by the image feature extraction model 12 and the textual description of the search object, and then match it with the representation vector of the search term. However, the applicant found that the accuracy of the search objects recalled using the above method is not high enough, and the matching degree with the search term is not good enough.

According to the applicant's analysis, the reasons for the above problems are mainly as follows: usually, the pre-trained image feature extraction model 12 is trained using a general image dataset, while images in a search scenario have their own particularities. For example, taking product images in an e-commerce scenario as an example, such images are usually main images of products, and thus the number of objects in the images is often relatively limited, for example, only including the product. However, images in the general image dataset used for pre-training the image feature extraction model 12 cover various types of images and do not have the above characteristics. That is, there is a certain difference between the dataset used in the pre-training stage of the image feature extraction model 12 and the dataset used in the application stage, resulting in a possible decline in the performance of the pre-trained image feature extraction model 12, and the extracted features are not comprehensive and accurate enough.

In order to obtain a more accurate representation vector of a search object, the embodiments of the present disclosure contemplate combining the above two methods. As shown in FIG. 5, when determining the representation vector of the search object, the image of the search object may be first subjected to partitioning processing to obtain a plurality of image patches of the search object, and then the pre-trained image feature extraction model 12 is used to respectively perform feature extraction on the plurality of image patches to obtain a feature sequence of the image patches. By cutting a whole image into a plurality of image patches, it is convenient for the image feature extraction model 12 to understand the image and extract finer-grained features. Moreover, since the image feature extraction model 12 is a model specifically used for image feature extraction, it can extract some implicit and high-order image patch features from the image patches. At the same time, considering that the image feature extraction model 12 is pre-trained using a general image dataset, there is a certain deviation between these image datasets and the image of the search object, resulting in the extracted feature sequence of the image patches possibly being not comprehensive and accurate enough. Therefore, the text feature extraction model 11 can be further used to perform feature extraction on the original image of the search object to extract some low-order original pixel-level features therefrom. Then, the text feature extraction model 11 can obtain the representation vector of the search object by combining the pixel-level features, the feature sequence of the image patches, and the text features extracted from the textual description of the search object. Since the feature sequence extracted by the image feature extraction model 12 and the pixel-level features extracted by the text feature extraction model 11 respectively represent high-level and low-level features of the image, the finally determined features of the image of the search object are more comprehensive and accurate, and thus the representation vector of the search object constructed based on the features of the image and the text features of the textual description is also more accurate.

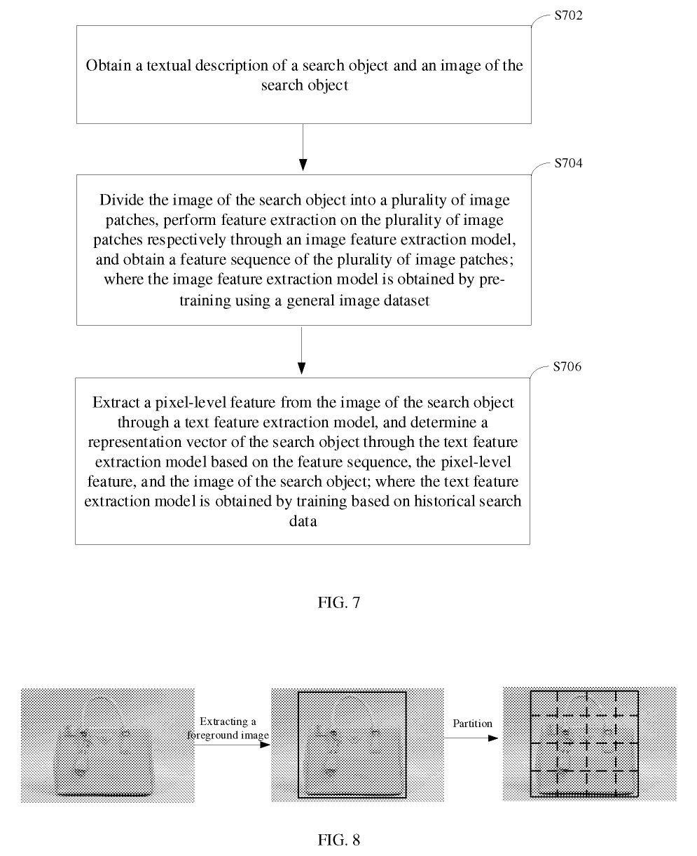

As shown in FIG. 6, which is a schematic diagram of a search application scenario, a search system may include a client 21 and a server 22. The client 21 may be provided on a terminal device such as a user's mobile phone or computer, and the server 22 may be provided in a server or a server cluster. For some specific search scenarios (the figure takes product search in an e-commerce scenario as an example), a large amount of attribute data of the product, such as textual descriptions of the product and images of the product, is pre-stored in the server 22. In order to improve the response efficiency to a user's search request, usually, for each product, the server 22 pre-constructs and stores a representation vector of the product. After the user inputs a search term, a representation vector of the search term can be determined, and then matching is performed based on the representation vector of the search term and the stored representation vector of the product to determine a product having a high correlation with the search term and return it to the user.

The representation method of the embodiments of the present disclosure may be executed by the server 22, that is, the representation vector of each search object is constructed through the server 22. Specifically, as shown in FIG. 7, the representation method for the search object may include the following steps:

S702: Obtain a textual description of a search object and an image of the search object;

In step S702, for each search object to be represented, the textual description of the search object and the image of the search object can be obtained; where the textual description may be various contents describing characteristics of the search object in words, such as a title of the search object and an introduction of the search object. The image of the search object may be one or more frames of images including the search object, for example, it may be a main image of the search object, and the image usually only includes the search object.

In S704, divide the image of the search object into a plurality of image patches, perform feature extraction on the plurality of image patches respectively through an image feature extraction model 12, and obtain a feature sequence of the plurality of image patches; where the image feature extraction model 12 is obtained by pre-training using a general image dataset.

Similar to the processing of text, considering that directly inputting a long text into a model may be difficult for the model to understand, processing the text into a plurality of words through word segmentation can facilitate the understanding of the model and extract more useful information. A similar method can also be adopted for the processing of images, that is, after an image is divided into a plurality of image patches, the image patches are respectively input into a model, and the model performs feature extraction on the image patches to extract more and finer-grained useful information. Therefore, in step S704, the image of the search object can be first subjected to patch processing to obtain a plurality of image patches. In order to obtain some implicit, high-order features of the image, the pre-trained image feature extraction model 12 can be used to perform feature extraction on the plurality of image patches respectively to obtain a feature sequence of the plurality of image patches. The feature of each image patch can be represented by a vector or a vector group, and the feature sequence can be a sequence composed of a plurality of vectors or vector groups.

The image feature extraction model 12 can be obtained by pre-training using a general image dataset, and the image feature extraction model 12 can be some open-source models, such as a ResNet model.

S706: Extract a pixel-level feature from the image of the search object through a text feature extraction model 11, and determine a representation vector of the search object through the text feature extraction model 11 based on the feature sequence, the pixel-level feature, and the image of the search object; where the text feature extraction model 11 is obtained by training based on historical search data.

In step S706, in a search scenario, in order to determine the representation vector of the search object and the representation vector of the search term to match the two, the text feature extraction model 11 is usually pre-trained. The text feature extraction model 11 can be obtained by training using historical search data, and it can map the search object and the search term to the same vector space to compare whether the two are close. The historical search data may be some search terms historically input by users, search objects returned based on the search terms that users have clicked or browsed, as well as textual descriptions, image data, and the like of the search objects.

Considering that the image feature extraction model 12 is obtained by training using a general image dataset, while the image of the search object has its specificity and has a certain deviation from the general image dataset. Therefore, the feature sequence extracted using the image feature extraction model 12 may not be accurate and comprehensive. To alleviate the above problem, when using the text feature extraction model 11 to determine the representation vector of the search object, the image of the search object can also be input to the text feature extraction model 11. Since the image of the search object retains the original features of the image, that is, the text feature extraction model 11 can extract some low-order, pixel-level features therefrom, thereby making up for the defects existing in the extracted high-order image patch feature sequence. Furthermore, the text feature extraction model 11 can combine the feature sequence and the pixel-level feature to obtain more accurate and comprehensive features of the image of the search object. Meanwhile, the text feature extraction model 11 can perform feature extraction on the textual description of the search object, map the features of the image of the search object and the features of the text of the search object to the same vector space, and then combine the two, so as to determine a representation vector used to describe the characteristics of the search object from multiple dimensions.

Considering that in addition to the search object, the image may also include some meaningless backgrounds, when the image feature extraction model 12 performs feature extraction on the search object, these meaningless backgrounds may cause certain interference to the image feature extraction model 12, which affects both the processing efficiency of the image feature extraction model 12, and the accuracy of the extracted features.

Therefore, in some embodiments, as shown in FIG. 8, before the image patches of the search object are subjected to partitioning processing, a foreground object may be first extracted from the image of the search object. Since the main body of the image is usually the search object, the extracted foreground object is likely to be the search object. Then, an image region corresponding to the foreground object may be divided into a plurality of image patches. The size of the image patches may be set based on actual conditions. Then, the plurality of image patches are respectively input into the image feature extraction model 12, and the image feature extraction model 12 respectively performs feature extraction on the plurality of image patches to determine respective features of the plurality of image patches, so as to obtain a feature sequence of the plurality of image patches. For each image patch, its features include both features such as contours and colors of the image patch obtained by the image feature model performing extraction on the image patch, and features used to represent the position of the image patch in the image.

In some embodiments, considering that the textual description of the search object is often a long text, in order to allow the text feature extraction model 11 to better understand the text semantics, the textual description of the search object can be first subjected to word segmentation processing, and then the text feature extraction model 11 is used to perform feature extraction thereon. For example, the textual description of the search object can be first subjected to word segmentation processing to obtain a plurality of words, and then respective representation vectors of the plurality of words are determined. For each word, its representation vector can be obtained based on a word vector of the word itself and a position vector representing the position of the word in the textual description. The word vector of the word can be determined with the aid of a pre-constructed vocabulary, and its function is to convert the word into information that the model can understand. After the representation vectors of the plurality of words are determined, the representation vectors of the plurality of words, the aforementioned obtained feature sequence, and the image of the search object can be input to the text feature extraction model 11 extracts pixel-level features from the image of the search object, and then the representation vector of the search object is determined based on the representation vectors of the plurality of words, the aforementioned obtained feature sequence, and the pixel-level features.

In the related art, when the text feature extraction model 11 is obtained by training, it usually includes two stages: a pre-training stage and a fine-tuning stage. In the pre-training stage, an initial model 13 (for example, a Bert model) can be trained using a large amount of corpus data. This process is usually unsupervised training, resulting a pre-trained initial model 14, which has a good understanding ability of text. The fine-tuning stage is mainly to let the pre-trained model learn a specific task on a specific dataset, so that the model has a good performance on the specific task. The fine-tuning stage is usually supervised training and requires pre-constructing labeled sample data. For example, the specific dataset may be sample data constructed based on historical search data, the sample data may include attribute data of a search object, as well as search terms that match or do not match the search object, and the specific task may be to let the model predict whether the search object and the search term match. Since the pre-training stage usually does not require labeling samples, through this pre-training + fine-tuning method, a model with better performance can be obtained by training even when the number of labeled samples is small.

Similarly, when the text feature extraction model 11 is obtained by training in the embodiments of the present disclosure, it can also include two stages, namely, a pre-training stage and a fine-tuning stage. In the pre-training stage, a preset initial model 13 can be pre-trained, and in the fine-tuning stage, the pre-trained initial model 14 can be further trained using a sample dataset constructed from historical search data to obtain the text feature extraction model 11.

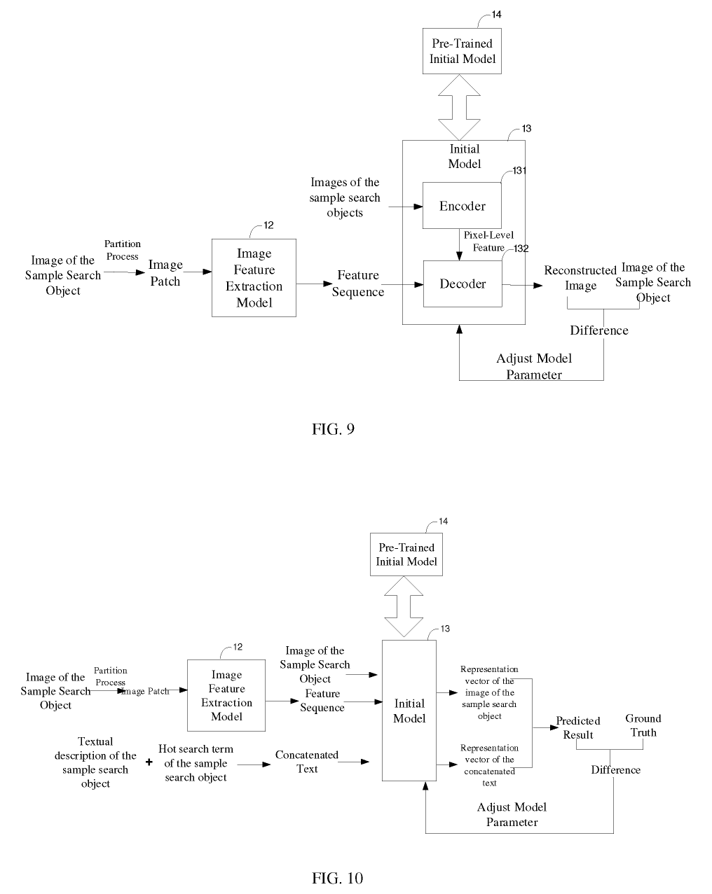

In the embodiments of the present disclosure, it is considered that the text feature extraction model 11 not only needs to process text to extract text features, but also needs to process the image of the search object to obtain comprehensive and accurate image features. Therefore, in some embodiments, in a pre-training stage of the text feature extraction model 11, images of a large number of search objects (hereinafter, search objects involved in the training stage are referred to as sample search objects) may be obtained from a database of the search system, and unsupervised training is performed on a preset initial model 13 using the images of the large number of sample search objects, so as to improve the ability of the pre-trained initial model 14 to perform feature extraction on images. For example, as shown in FIG. 9, the initial model 13 may include an encoder 131 and a decoder 132. When pre-training the initial model 13, images of a large number of sample search objects can be obtained from the search system. For each frame of the image of the sample search object, it can be divided into a plurality of image patches. Through the aforementioned image feature extraction model 12, feature extraction is respectively performed on the plurality of image patches, to obtain a feature sequence of the plurality of image patches (hereinafter, the feature sequence of the image patches extracted in the training stage is referred to as a sample feature sequence). Then, the image of the sample search object can be input into the encoder 131, and pixel-level features are extracted from the image of the sample search object through the encoder 131. The decoder 132 can reconstruct the image of the sample search object based on the sample feature sequence and the pixel-level features to obtain a reconstructed image. Then, model parameters of the initial model 13 are adjusted based on a difference between the reconstructed image and the image of the sample search object, so as to pre-train the initial model 13. By pre-training the initial model 13 in the above manner, the pre-trained initial model 14 can have better image feature extraction performance, so that the pre-trained initial model 14 can obtain more accurate image features.

In some embodiments, considering that the task of the text feature extraction model 11 is either to perform feature extraction on text or to perform feature extraction on images. The aforementioned pre-training process can improve the performance of the model in performing feature extraction on images. In order to further improve the performance of the model in performing feature extraction on text, textual descriptions of a large number of sample search objects can be obtained from a database of a search system, and then these textual descriptions are used as corpus data to perform unsupervised training on the preset initial model 13. For example, in the process of pre-training the initial model 13, for a text, a certain word in the text can be masked, and then the initial model 13 is used to predict what the masked word is based on the context of the text, and model parameters of the initial model 13 are adjusted based on a difference between a predicted result of the initial model 13 and a ground truth, so as to pre-train the initial model. By using textual descriptions of a large number of sample search objects as corpus data to train the initial model 13, the ability of the initial model 13 to understand text can be improved.

In a search scenario, there are often large differences in structure, expression mode, and the like between the textual description of a search object and a search term. For example, the textual description of a search object is often a long text, and its sentence structure and expression mode have specific characteristics, while a search term is often a short word, which is relatively concise and refined. Taking product search in an e-commerce scenario as an example, the title of a product is the language of the seller, while the search term is the language of the user. Obviously, there is often a large semantic difference between the search term and the title of the product. In the related art, the same model is directly used to map the search term and the textual description of the search object to the same vector space, ignoring the semantic difference between the two, which may lead to an inaccurate finally output representation vector. In order to alleviate the semantic difference between the textual description of the search object and the search term, in some embodiments, for each sample search object, a hot search term of the sample search object can be obtained, and the hot search term is combined with the textual description of the sample search object to pre-train the initial model 13, so that the initial model 13 can better learn the difference between the search term and the textual description of the sample search object. The hot search term of the sample search object may be one or more search terms with a high click-through rate for the sample search object. For example, the number of times the sample search object is clicked after a user inputs a certain search term can be counted, and then the top N search terms with the most clicks for the sample search object are used as the hot search terms of the sample search object. For each sample search object, the hot search term corresponding to the sample search object can be determined based on historical search data.

As shown in FIG. 10, when pre-training the initial model 13, a hot search term corresponding to a sample search object, a textual description of the sample search object, and an image of the sample search object may be obtained. Then, the textual description of the sample search object and a hot search term of the sample search object can be concatenated to obtain concatenated text. The image of the sample search object is divided into a plurality of image patches, and feature extraction is respectively performed on the plurality of image patches through the image feature extraction model 12, to obtain a sample feature sequence of the plurality of image patches. The sample feature sequence, the image of the sample search object, and the concatenated text are input into the initial model 13. The initial model 13 can extract pixel-level features from the image of the search object and extract text features from the concatenated text, and then can determine a representation vector of the image of the sample search object based on the sample feature sequence and the pixel-level features, and determine a representation vector of the concatenated text based on the text features, that is, map the concatenated text and the image of the sample search object into the same vector space. Then, it can be predicted whether the concatenated text and the image of the sample search object match. For example, if the representation vectors of the two are relatively close, that is, the similarity between the representation vectors of the two is greater than a preset similarity, it is considered that the two match. Then, the model parameters of the initial model 13 can be adjusted based on a deviation between a predicted result and a ground truth, so as to pre-train the initial model 13. Since the concatenated text is text obtained by concatenating the textual description of the search object and the hot search term, that is, it can be considered to match the search object, the ground truth is that the two match.

Since the textual description of the sample search object and the hot search term of the sample search object are fused together during the pre-training process and then matched with the image of the sample search object, the model can better learn the semantic difference between the textual description of the sample search object and the search term during the training process, which in turn can alleviate the problem that the finally recalled search object does not match the search term caused by the difference between the two.

Of course, when the initial model 13 is actually pre-trained, one or more of the above three pre-training processes may be included. When the above three pre-training processes are included at the same time, the three pre-training processes can be performed separately or simultaneously, which is not limited in the embodiments of the present disclosure.

For example, in some scenarios, in order to make the pre-trained initial model 14 have better performance, the pre-training process can include the above three pre-training processes at the same time, and the three pre-training processes can be performed simultaneously, that is, the initial model 13 is pre-trained by using a joint training method.

For example, as shown in FIG. 11, the image of the sample search object may be first subjected to partitioning processing to obtain a plurality of image patches, and then the image feature extraction model 12 is used to perform feature extraction on the plurality of images to obtain a sample feature sequence. Then, the textual description of the sample search object, the hot search term of the sample search object, the image of the sample search object, and the sample feature sequence can be simultaneously input into the initial model 13, and the initial model 13 can simultaneously perform the above three prediction tasks based on the input data, namely, a task of predicting masked words in combination with text context, a task of reconstructing the image of the sample search object, and a task of determining whether the concatenated text of the textual description of the sample search object and the hot search term matches the image of the sample search object. Then, the initial model 13 can output respective predicted results corresponding to the above three prediction tasks, determine a target loss based on differences between the predicted results of the above three tasks and ground truths, and adjust the model parameters of the initial model 13 based on the target loss.

Through pre-training the initial model 13 in the above pre-training stage, the pre-trained initial model 14 can already well fuse information of different modalities such as the image and text of the search object to obtain a relatively accurate representation vector of the search object. However, in the recall stage of the search scenario, since the search object fuses information of different modalities such as text and image, there will be a relatively large difference between it and the search term. If the method provided in the related art is still used to fine-tune the pre-trained model to obtain the text feature extraction model 11, then after the text feature extraction model 11 maps the search object and the search term to the same vector space in the application stage, the representation vectors of the two are seriously fragmented. That is, the representation vector of the search term will be distributed in one region of the space, and the representation vector of the search object will be distributed in another region of the space. Since the recall stage usually uses a KNN (K-Nearest Neighbor) algorithm to search for N representation vectors of search objects closest to the representation vector of the search term and returns these N representation vectors of search objects to the user, it is usually desired that the distribution difference between the representation vector of the search term and the representation vector of the search object in the vector space should not be too large, and they should be in a common subspace as much as possible.

Therefore, in some embodiments, in the process of fine-tuning the pre-trained initial model 13, an adversarial learning mechanism can be introduced to eliminate the large difference in the distribution of representation vectors in the vector space between the search object and the search term caused by including information of different modalities after finally mapping the two to the same vector space.

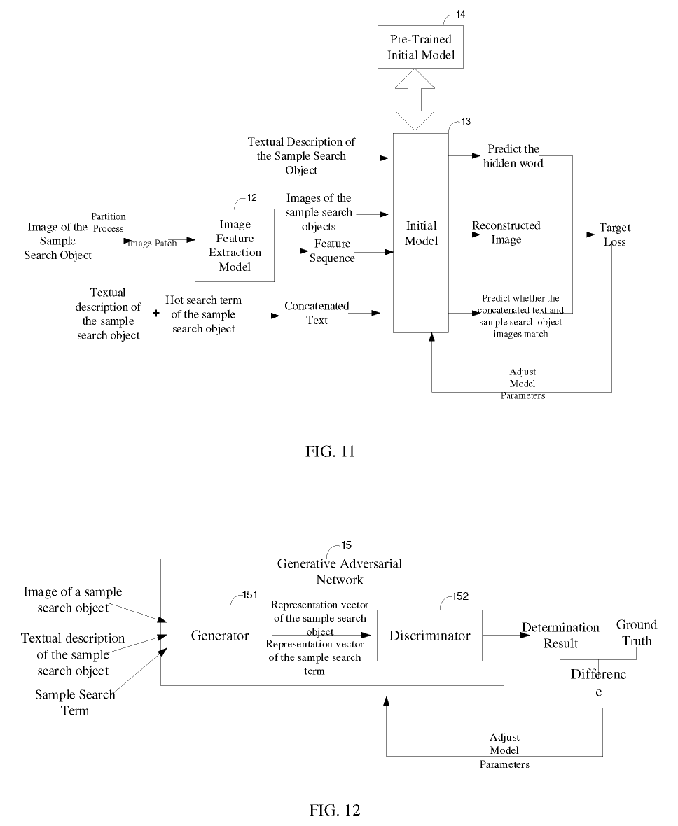

As shown in FIG. 12, a generative adversarial model 15 (Generative Adversarial Network, GAN) generally includes a generator 151 and a discriminator 152. Its main idea is to realize model training through continuous confrontation between the generator 151 and the discriminator 152 during the training process. Taking generating relatively close representation vectors of a search object and representation vectors of a search term through the generative adversarial model 15 as an example, the generator 151 can be used to respectively generate the representation vector of the search object and the representation vector of the search term based on attribute data of the search term and the search object. Then, the discriminator 152 is used to distinguish which is the representation vector of the search object and which is the representation vector of the search term, and then the model parameters of the generator 151 and the discriminator 152 can be adjusted based on a determination result to train both. The purpose of the training process is to make the representation vector of the search object generated by the generator 151 as close as possible to the representation vector of the search term, so that the discriminator 152 cannot distinguish between the two. At the same time, the discriminator 152 is required to determine which is the representation vector of the search object and which is the representation vector of the search term as accurately as possible. The entire training process is a process of continuous confrontation between the generator 151 and the discriminator 152, so that the difference between the representation vector of the search term and the representation vector of the search object generated by the finally trained generator 151 will not be too large, and they will be in the same common subspace as much as possible.

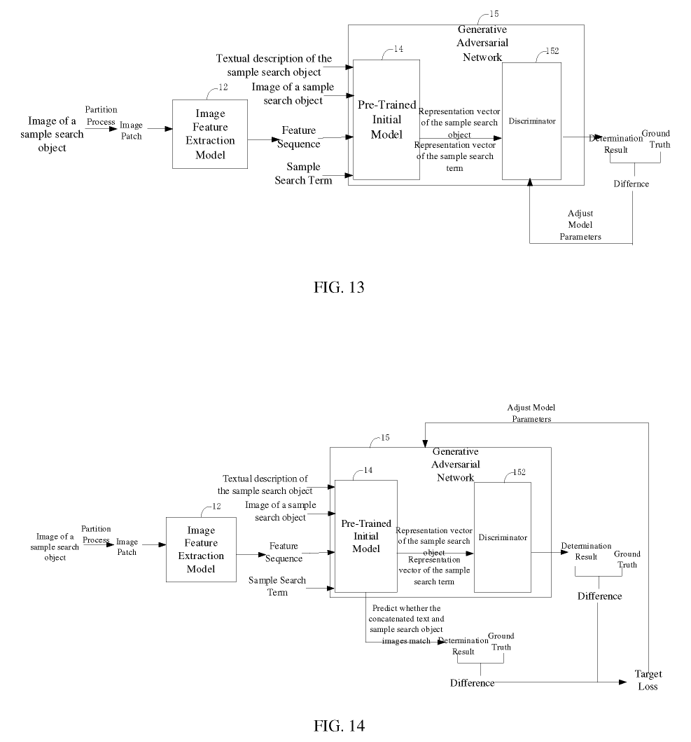

In the embodiments of the present disclosure, as shown in FIG. 13, the pre-trained initial model 14 can be used as the generator 151 of the generative adversarial model 15. In the process of fine-tuning the pre-trained initial model 13, sample data can be obtained, where the sample data includes a sample search term, an image of a sample search object, and a textual description of the sample search object. Then, the image of the sample search object can be divided into a plurality of image patches, and through the aforementioned image feature extraction model 12, feature extraction is respectively performed on the plurality of image patches, to obtain a sample feature sequence of the plurality of image patches. Then, the sample search term, the image of the sample search object, the textual description of the sample search object, and the sample feature sequence can be input into the pre-trained initial model 14. The pre-trained initial model 14 can extract pixel-level features from the image of the sample search object, determine image features of the sample search object based on the pixel-level features and the sample feature sequence, then determine text features of the sample search object based on the textual description of the sample search object, and obtain a representation vector of the sample search object by combining the image features and the text features. Then, a representation vector of the sample search term can be determined.

After obtaining the representation vector of the sample search object and the representation vector of the sample search term, the representation vectors of the two can be input into a preset discriminator 152, and the discriminator 152 determines the type to which the input representation vector belongs, that is, the discriminator 152 determines whether the input representation vector is the representation vector of the sample search object or the representation vector of the search term. Then, a target loss can be determined based on a difference between a determination result of the discriminator 152 and a ground truth, and the model parameters of the pre-trained initial model 14 are adjusted according to the target loss to train and obtain the text feature extraction model 11. For example, if the representation vector input to the discriminator 152 is the representation vector of the sample search object, but the discriminator 152 predicts it as the representation vector of the sample search term, the predicted result of the model is inaccurate.

In the process of adversarial learning, the purpose of training the generator 151 (i.e., the pre-trained initial model 14) is to make the finally generated representation vector of the sample search object and the representation vector of the search term as close as possible, so that the discriminator 152 cannot accurately distinguish between the two. The purpose of training the discriminator 152 is to enable the discriminator 152 to accurately distinguish between the two. Through the mutual confrontation between the two, after the final generator 151 (i.e., the pre-trained initial model 14) maps the search object and the search term to the same vector space, the distributions of the representation vectors of the two will be relatively close and can be in a common subspace as much as possible, which is convenient for subsequent recall.

In some embodiments, in the fine-tuning stage, in addition to determining a loss based on a difference between a discrimination result of the discriminator 152 and a ground truth, to adjust parameters of the pre-trained initial model 14, the pre-trained initial model 14 can also be simultaneously allowed to perform a prediction task of whether a sample search object and a sample search term in sample data match, and the parameters of the pre-trained initial model 14 are adjusted based on a difference between a predicted result of the prediction task and a ground truth. That is, a loss function can be comprehensively determined by combining processing results of the pre-trained initial model 14 for the above two tasks, to adjust model parameters, so that a text feature extraction model 11 with good performance and higher accuracy can be trained.

For example, the sample data may also carry a label, and the label is used to indicate whether the sample search term and the sample search object match. Matching of the sample search term and the sample search object means that the sample search object is an object pointed to by the sample search term. For example, if the sample search term is "dress" and the sample search object is "dress", the two match; if the sample search object is "shoes", the two do not match. In addition, matching may mean that both the textual description and the image of the search object match the search term.

As shown in FIG. 14, when a target loss is determined based on a difference between a determination result of the discriminator 152 and a ground truth, a first loss can be first determined based on the difference between the determination result of the discriminator 152 and the ground truth. Then, the sample search term, the image of the sample search object, the textual description of the sample search object, and the sample feature sequence can be input into the pre-trained initial model 14, and a predicted result is output through the pre-trained initial model 14, where the predicted result is used to indicate whether the sample search term and the sample search object match. Furthermore, a second loss can be determined based on a difference between the determination result of the discriminator 152 and the ground truth indicated by the label, the target loss is obtained according to the first loss and the second loss, and then model parameters of the pre-trained initial model 14 are adjusted based on the target loss to train and obtain the text feature extraction model 11. For example, the target loss can be obtained by performing weighted processing on the two losses according to certain weights and then adding them.

In some embodiments, the training of the generative adversarial model 15 can be divided into two stages. In the first stage, the model parameters of the discriminator 152 are fixed and no gradient update is performed, and only the model parameters of the pre-trained initial model 14 are updated. In this stage, the model parameters of the pre-trained initial model 14 can be adjusted based on two losses. One is a loss determined based on a task of the discriminator 152 distinguishing whether an input representation vector is a representation vector of a sample search term or a representation vector of a sample search object, and the other is a loss determined based on a task of the pre-trained initial model 14 predicting whether the sample search term and the sample search object match. In the second stage, the model parameters of the pre-trained initial model 14 are fixed, and only the parameters of the discriminator 152 are gradient-updated. In this stage, the model parameters of the discriminator 152 are adjusted based on only one loss, which is a loss determined based on the task of the discriminator 152 distinguishing whether the input representation vector is a representation vector of a sample search term or a representation vector of a sample search object. The above two stages can be continuously repeated during the entire training process until convergence.

In some embodiments, in order to ensure the accuracy of the finally trained text feature extraction model 11, diversity of sample data can be ensured as much as possible when constructing the sample data. For example, the sample data may include positive samples and negative samples, where a sample search term and a sample search object in a positive sample match, and a sample search term and a search object in a negative sample do not match.

In some embodiments, when constructing the sample data, historical search data can be obtained, search terms used by users are determined according to the historical search data, and after search objects are returned based on the search terms, search objects clicked by users are determined from the returned search objects; then, the search term can be used as a sample search term in a positive sample, and any search object clicked by a user can be used as a sample search object in a positive sample to construct the positive sample. The search term is used as a sample search term in a negative sample, and any search object not clicked by a user is used as a sample search object in a negative sample to construct the negative sample.

Similarly, in the stage of training the text feature extraction model 11 (including the pre-training stage and the fine-tuning stage), in order to eliminate interference of a meaningless background part in the image of the sample search object and to extract more effective information from the image, a foreground object can also be first extracted from the image of the sample search object, and an image region corresponding to the foreground object is divided into a plurality of image patches; the plurality of image patches are respectively input into the image feature extraction model 12, and the image feature extraction model 12 performs feature extraction on the plurality of image patches respectively to obtain a sample feature sequence.

Similarly, the processing for the textual description of the sample search object and the aforementioned concatenated text is also similar, and they can also be first subjected to word segmentation processing to obtain representation vectors of various words, and then input into the initial model 13 or the pre-trained initial model 14.

In some embodiments, the initial model may be a BERT model, the method may be used for product search in an e-commerce scenario, and the search object may be a product in an e-commerce scenario.

Further, the embodiments of the present disclosure also provide a search method, which can be used in various search scenarios, for example, can be used for product search in an e-commerce scenario. The specific process of the method is as follows:

a search term input by a user can be obtained, and then the aforementioned text feature extraction model can be used to determine a representation vector of the search term. The text feature extraction model can be obtained by training using the method introduced in the foregoing embodiments, which will not be repeated here. Then, representation vectors of a plurality of search objects can be obtained, where the representation vector of the search object can be obtained in the manner introduced in each embodiment of the above representation method, and reference may be made to the description in the above embodiments for details, which will not be repeated here. After the representation vectors of the search term and the plurality of search objects are obtained, candidate objects can be determined from the plurality of search objects based on the similarity between the representation vector of the search term and the respective representation vectors of the plurality of search objects, so as to display attribute data of the candidate objects to the user. For example, a KNN algorithm can be used to determine N search objects closest to the representation vector of the search term from the representation vectors of the plurality of search objects, and then attribute data such as images and textual descriptions of the N search objects are displayed to the user.

Further, the embodiments of the present disclosure also provide a model training method, the method comprising the following steps:

obtaining an image of a sample search object;

dividing the image of the sample search object into a plurality of image patches, performing feature extraction on the plurality of image patches respectively through an image feature extraction model, to obtain a sample feature sequence of the plurality of image patches, where the image feature extraction model is obtained by pre-training using a general image dataset;

extracting pixel-level features from the image of the sample search object through an encoder of a preset initial model;

reconstructing the image of the sample search object through a decoder of the initial model based on the sample feature sequence and the pixel-level features to obtain a reconstructed image;

adjusting model parameters of the initial model based on a difference between the reconstructed image and the image of the sample search object to pre-train the initial model;

fine-tuning the pre-trained initial model based on historical search data to obtain a text feature extraction model.

Specific implementation details of model training may refer to the description in the above embodiments, and will not be repeated here.

Further, the embodiments of the present disclosure also provide a model training method, the method comprising the following steps:

obtaining a hot search term corresponding to a sample search object, a textual description of the sample search object, and an image of the sample search object;

concatenating the hot search term of the sample search object and the textual description of the sample search object to obtain concatenated text;

dividing the image of the sample search object into a plurality of image patches, performing feature extraction on the plurality of image patches respectively through an image feature extraction model, to obtain a sample feature sequence of the plurality of image patches, where the image feature extraction model is obtained by pre-training using a general image dataset;

inputting the sample feature sequence, the image of the sample search object, and the concatenated text into a preset initial model, and outputting a predicted result through the initial model, the predicted result being used to indicate whether the concatenated text and the image of the sample search object match;

adjusting model parameters of the initial model based on a deviation between the outputted predicted result and a ground truth to pre-train the initial model;

fine-tuning the pre-trained initial model based on historical search data to obtain a text feature extraction model.

Specific implementation details of model training may refer to the description in the above embodiments, and will not be repeated here.

Further, the embodiments of the present disclosure also provide a model training method, the method comprising the following steps:

pre-training a preset initial model based on historical search data;

obtaining sample data, the sample data including a sample search term, an image of a sample search object, and a textual description of the sample search object;

dividing the image of the sample search object into a plurality of image patches, performing feature extraction on the plurality of image patches respectively through the image feature extraction model, to obtain a sample feature sequence of the plurality of image patches, where the image feature extraction model is obtained by pre-training using a general image dataset;

inputting the sample search term, the image of the sample search object, the textual description of the sample search object, and the sample feature sequence into the pre-trained initial model, and outputting a representation vector of the sample search term and a representation vector of the sample search object through the pre-trained initial model;

inputting the representation vector of the sample search term and the representation vector of the sample search object respectively into a preset discriminator, and using the discriminator to determine a type to which the inputted representation vector belongs, the type including a search term or a search object;

determining a target loss based on a difference between a determination result of the discriminator and a ground truth;

adjusting model parameters of the pre-trained initial model according to the target loss to train and obtain the text feature extraction model.

Specific implementation details of model training may refer to the description in the above embodiments, and will not be repeated here.

Corresponding to the embodiments of the search object representation method, the search method, and the model training method provided by the embodiments of the present specification, the present specification also provides a search object representation apparatus, a search apparatus, and a model training apparatus. For the implementation process of the functions and roles of each unit in the above apparatuses, reference may be made to the implementation process of corresponding steps in the above methods for details, which will not be repeated here.

As for the apparatus embodiments, since they basically correspond to the method embodiments, reference may be made to the partial description of the method embodiments for relevant parts. The apparatus embodiments described above are merely illustrative, where the units described as separate components may or may not be physically separate, and the components displayed as units may or may not be physical units, that is, they may be located in one place or may be distributed to a plurality of network units. Some or all of the modules can be selected according to actual needs to achieve the purpose of the solution of the embodiments of the present specification. Those of ordinary skill in the art can understand and implement it without creative labor.

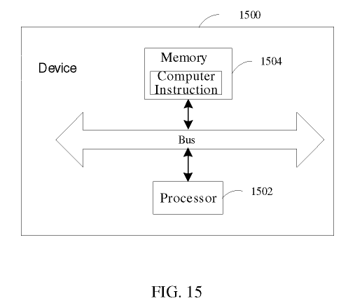

From a hardware level, as shown in FIG. 15, which is a hardware structural diagram of a device where a search object representation apparatus, a search apparatus, and/or a model training apparatus of the embodiments of the present specification are located, in addition to a processor 1502 and a memory 1504 shown in FIG. 15, the device may generally include other hardware, such as a forwarding chip responsible for processing packets; in terms of hardware structure, the device may also be a distributed device, and may include multiple interface cards to expand packet processing at the hardware level. The memory 1504 stores computer instructions, and the processor 1502 implements the method mentioned in any of the above embodiments when executing the computer instructions.

User information (including but not limited to user device information, user personal information, etc.) and data (including but not limited to data used for analysis, stored data, displayed data, etc.) involved in the present disclosure are all information and data authorized by the user or fully authorized by all parties, and the collection, use, and processing of relevant data need to comply with relevant laws, regulations, and standards of relevant countries and regions, and corresponding operation entries are provided for users to choose to authorize or refuse.

Since the part of the embodiments of the present specification that makes contributions to the prior art or all or part of the technical solution can be embodied in the form of a software product, the computer software product is stored in a storage medium and includes several instructions to enable a terminal device to perform all or part of the steps of the methods of various embodiments of the present specification. The aforementioned storage medium includes: various media that can store program codes, such as a USB flash drive, a mobile hard disk, a Read-Only Memory (ROM), a Random Access Memory (RAM), a magnetic disk, or an optical disk.

The above are only preferred embodiments of the embodiments of the present specification and are not intended to limit the embodiments of the present specification. Any modification, equivalent replacement, improvement, etc. made within the spirit and principle of the embodiments of the present specification shall be included in the protection scope of the embodiments of the present specification.

1. A method for generating a representation of a search object comprising:
obtaining a textual description of a search object and an image of the search object;
dividing the image of the search object into a plurality of image patches, performing feature extraction on the plurality of image patches respectively through an image feature extraction model, and obtaining a feature sequence of the plurality of image patches, wherein the image feature extraction model is obtained by pre-training using a general image dataset;
extracting a pixel-level feature from the image of the search object through a text feature extraction model, and determining a representation vector of the search object through the text feature extraction model based on the feature sequence, the pixel-level feature, and the image of the search object, wherein the text feature extraction model is obtained by training based on historical search data.

2. The method according to claim 1, wherein the dividing the image of the search object into the plurality of image patches comprises:
extracting a foreground object from the image of the search object; and
dividing an image region corresponding to the foreground object into the plurality of image patches.

3. The method according to claim 1, wherein the determining, by the text feature extraction model, the representation vector of the search object based on the feature sequence, the pixel-level feature, and the textual description of the search object comprises:
performing word segmentation on the textual description of the search object to obtain a plurality of words;
determining respective representation vectors of the plurality of words, wherein the representation vectors are obtained based on word vectors of the words and position vectors representing positions of the words in the textual description; and
determining, by the text feature extraction model, the representation vector of the search object based on the feature sequence, the pixel-level feature, and the respective representation vectors of the plurality of words.

4. The method according to claim 1, wherein the text feature extraction model is obtained by training based on historical search data, the training based on historical search data comprising:
performing pre-training on an initial model; and
fine-tuning the pre-trained initial model based on historical search data to obtain the text feature extraction model;
wherein a process of performing pre-training on the initial model comprises:
obtaining an image of a sample search object; dividing the image of the sample search object into a plurality of image patches; performing feature extraction on the plurality of image patches respectively through the image feature extraction model, to obtain a sample feature sequence of the plurality of image patches; extracting a pixel-level feature from the image of the sample search object through an encoder of the initial model; reconstructing the image of the sample search object through a decoder of the initial model based on the sample feature sequence and the pixel-level feature to obtain a reconstructed image; and adjusting model parameters of the initial model based on a difference between the reconstructed image and the image of the sample search object to pre-train the initial model;
and/or
obtaining a hot search term corresponding to a sample search object, a textual description of the sample search object, and an image of the sample search object; concatenating the hot search term of the sample search object and the textual description of the sample search object to obtain concatenated text; dividing the image of the sample search object into a plurality of image patches; performing feature extraction on the plurality of image patches respectively through the image feature extraction model, to obtain a sample feature sequence of the plurality of image patches; inputting the sample feature sequence, the image of the sample search object, and the concatenated text into the initial model; outputting a predicted result through the initial model, the predicted result being used to indicate whether the concatenated text matches the image of the sample search object; and adjusting model parameters of the initial model based on a deviation between the outputted predicted result and a ground truth to pre-train the initial model;
and/or
obtaining textual descriptions of a plurality of sample search objects as corpus data, and performing unsupervised training on the initial model using the corpus data.

5. The method according to claim 1, wherein the text feature extraction model is obtained by training based on historical search data, the training based on historical search data comprising:
performing pre-training on an initial model based on historical search data;
obtaining sample data, wherein the sample data comprises a sample search term, an image of a sample search object, and a textual description of the sample search object;
dividing the image of the sample search object into a plurality of image patches; performing feature extraction on the plurality of image patches respectively through the image feature extraction model, to obtain a sample feature sequence of the plurality of image patches;
inputting the sample search term, the image of the sample search object, the textual description of the sample search object, and the sample feature sequence into the pre-trained initial model; outputting a representation vector of the sample search term and a representation vector of the sample search object through the pre-trained initial model;
inputting the representation vector of the sample search term and the representation vector of the sample search object respectively into a preset discriminator; using the discriminator to determine a type to which the inputted representation vector belongs, the type comprising a search term or a search object;
determining a target loss based on a difference between a determination result of the discriminator and a ground truth;
adjusting model parameters of the pre-trained initial model according to the target loss to obtain the text feature extraction model by training.

6. The method according to claim 5, wherein the sample data carries a label, the label being used to indicate whether the sample search term matches the sample search object; the determining the target loss based on the difference between the determination result of the discriminator and the ground truth comprises:
determining a first loss based on the difference between the determination result of the discriminator and the ground truth;
inputting the sample search term, the image of the sample search object, the textual description of the sample search object, and the sample feature sequence into the pre-trained initial model; outputting a predicted result through the pre-trained initial model, the predicted result being used to indicate whether the sample search term matches the sample search object;
determining a second loss based on a difference between the determination result of the discriminator and a ground truth indicated by the label;
obtaining the target loss according to the first loss and the second loss.

7. The method according to claim 6, wherein the sample data comprises a positive sample and a negative sample, the sample search term and the sample search object in the positive sample match, and the sample search term and the search object in the negative sample do not match.

8. The method according to claim 7, wherein the sample data is obtained based on the following manner:
obtaining historical search data;
determining a search term used by a user based on the historical search data, and determining a search object clicked by the user from search objects recalled through the search term;
constructing the positive sample by using the search term as the sample search term in the positive sample and using any search object clicked by the user as the sample search object in the positive sample; and
constructing the negative sample by using the search term as the sample search term in the negative sample and using any search object not clicked by the user as the sample search object in the negative sample.

9. The method according to claim 1 further comprising:
obtaining a search term inputted by a user and representation vectors of a plurality of search objects;
determining a representation vector of the search term using the text feature extraction model; and
determining a candidate object from the plurality of search objects based on similarities between the representation vector of the search term and the respective representation vectors of the plurality of search objects, to display attribute data of the candidate object to the user.

10. A non-transitory computer-readable storage medium configured with instructions executable by one or more processors to cause the one or more processors to perform the method of claim 1.

11. An electronic device comprising:
one or more processors; and
one or more computer-readable memories coupled to the one or more processors and having instructions stored thereon that are executable by the one or more processors to perform the method of claim 1.

12. A model training method comprising:
obtaining an image of a sample search object;
dividing the image of the sample search object into a plurality of image patches;
performing feature extraction on the plurality of image patches respectively through an image feature extraction model, to obtain a sample feature sequence of the plurality of image patches, wherein the image feature extraction model is obtained by pre-training using a general image dataset;
extracting a pixel-level feature from the image of the sample search object through an encoder of an initial model;
reconstructing the image of the sample search object through a decoder of the initial model based on the sample feature sequence and the pixel-level feature to obtain a reconstructed image;
adjusting model parameters of the initial model based on a difference between the reconstructed image and the image of the sample search object to pre-train the initial model; and
fine-tuning the pre-trained initial model based on historical search data to obtain a text feature extraction model.

13. A non-transitory computer-readable storage medium configured with instructions executable by one or more processors to cause the one or more processors to perform the method of claim 12.

14. An electronic device comprising:
one or more processors; and
one or more computer-readable memories coupled to the one or more processors and having instructions stored thereon that are executable by the one or more processors to perform the method of claim 12.

15. A model training method comprising:
obtaining a search term corresponding to a sample search object, a textual description of the sample search object, and an image of the sample search object;
concatenating the search term of the sample search object and the textual description of the sample search object to obtain concatenated text;
dividing the image of the sample search object into a plurality of image patches; performing feature extraction on the plurality of image patches respectively through an image feature extraction model, to obtain a sample feature sequence of the plurality of image patches, wherein the image feature extraction model is obtained by pre-training using a general image dataset;
inputting the sample feature sequence, the image of the sample search object, and the concatenated text into an initial model; outputting a predicted result through the initial model, the predicted result being used to indicate whether the concatenated text matches the image of the sample search object;
adjusting model parameters of the initial model based on a deviation between the outputted predicted result and a ground truth to pre-train the initial model; and
fine-tuning the pre-trained initial model based on historical search data to obtain a text feature extraction model.

16. A non-transitory computer-readable storage medium configured with instructions executable by one or more processors to cause the one or more processors to perform the method of claim 15.

17. An electronic device comprising:
one or more processors; and
one or more computer-readable memories coupled to the one or more processors and having instructions stored thereon that are executable by the one or more processors to perform the method of claim 15.
